(19) United States
(12) Patent Application Publication
(10) Pub. No.: US 2010/0085762 A1
(43) Pub. Date: Apr. 8, 2010

(54) OPTIMIZED SPATIAL POWER DISTRIBUTION FOR SOLID STATE LIGHT FIXTURES

(76) Inventor: Donald A. PEIFER, Mountain View, CA (US)

Correspondence Address: HESLIN ROTHENBERG FARLEY & MESITI PC, 5 COLUMBIA CIRCLE, ALBANY, NY, 12203, US

(21) Appl. No.: 12/572,587

(22) Filed: Oct. 2, 2009

Related U.S. Application Data
(60) Provisional application No. 61/102,490, filed on Oct. 3, 2008.
(60) Provisional application No. 61/102,379, filed on Oct. 3, 2008.

(51) Int. Cl. F21V 5/02; F21V 7/00

(52) U.S. Cl. 362/309; 362/307

(57) ABSTRACT

In one embodiment, a method for illuminating a work surface using a solid state lighting fixture includes generating light from a solid state light source, introducing the light into a light guide, reflecting some of the light from a reflector back into the light guide, and introducing light emitted from the light guide into at least one optical element. The emitted light from the at least one optical element has a shifted spatial power distribution to more closely approximate a vertical and horizontal Lambertian spatial power distribution, and the emitted light comprises a total zonal lumens of at least about 90-percent of the total zonal lumens emitted without the at least one optical element. The solid state lighting fixture being operable to emit non-polarized light to generally accurately reproduce colors of objects on the work surface.

### CROSS-REFERENCE TO RELATED APPLICATION

This application claims the benefit of U.S. Provisional Application No. 61/102,490, filed Oct. 3, 2008, entitled “Optimized Spatial Power Distribution For Solid State Light Fixture”, and U.S. Provisional Application No. 61/102,379, filed Oct. 3, 2008, entitled “Glare Reduction for Solid State Lighting Fixture”, which applications are incorporated in their entirety herein by reference.

### FIELD OF THE INVENTION

The present invention relates generally to lighting fixtures or luminaires, and more specifically, to solid state lighting fixtures or luminaires such as LED light fixtures or luminaires having an optimized spatial power distribution.

### BACKGROUND OF THE INVENTION

Lighting accounts for a large portion of the energy used in this country. In commercial lighting applications alone, lighting accounts for 40-percent of the energy used. Because of inherent efficiencies relative to all other lighting technologies, solid state lighting devices are poised to replace incandescent and fluorescent based lighting systems in most applications.

Finding a suitable fixture profile and form factor is important for the adoption of replacement technology into existing build environments. Considerable application issues face the common screw-based, LED, incandescent replacement lamps. One form factor that holds great promise is the solid state lighting thin panel, which is capable of being used in common drop-in ceilings as a replacement for the currently ubiquitous fluorescent troffer, e.g., an inverted trough suspended from a ceiling, as a fixture for fluorescent lighting tubes. Since they are thin, they can be used in zero plenum applications where overhead space is prohibitive. The fixtures can also be easily suspended for direct and semi-direct use.

In office lighting applications, lighting systems need to meet a mandate for minimum illumination standards, namely 20-50 foot candles on the work surface throughout the space. In order to achieve these values as a one-to-one replacement for fluorescent fixtures, solid state lighting panel fixtures would desirably deliver a minimum of about 3,500 lumens. The luminance profile of a fixture providing this amount of light is also important in office lighting applications.

Therefore, there is a need for further lighting fixtures or luminaires, and more specifically, to solid state light fixture such as LED lighting fixtures or luminaires having an optimized spatial power distribution.

### SUMMARY OF THE INVENTION

In a first aspect, the present invention provides a method for illuminating a work surface using a solid state lighting fixture. The method includes generating light from a solid state light source, introducing the light from the solid state light source into a generally horizontally disposed planar light guide, reflecting some of the light from a reflector disposed adjacent to a horizontally disposed top surface of the light guide back into the light guide, and introducing the light emitted from a horizontally disposed bottom surface of the light guide into at least one horizontally disposed optical element having a top surface disposed adjacent to the bottom surface of the light guide. Light emitted from the at least one horizontally disposed optical element has a shifted spatial power distribution of the light due to the at least one horizontally disposed optical element to more closely approximate a vertical Lambertian spatial power distribution and a horozontal Lambertian spatial power distribution compared to the spatial power distributions of light without the at least one horizontally disposed optical element. The emitted light from the at least one horizontally disposed optical element comprises a total zonal lumens over the spatial power distribution of at least about 90-percent of the total lumens emitted without the at least one horizontally disposed optical element. The emitted light is non-polarized and operable to generally accurately reproduce colors of objects. The work surface is illuminated with the non-polarized light having the shifted spatial power distribution to generally accurately reproduce colors of objects on the work surface.

In a second aspect, the present invention provides a method for illuminating a work surface using a solid state lighting fixture. The method includes generating light from a solid state light source, introducing the light from the solid state light source into a generally horizontally disposed planar light guide, reflecting some of the light from a reflector disposed adjacent to a horizontally disposed top surface of the light guide back into the light guide, and introducing the light emitted from the horizontally disposed bottom surface of the light guide into at least one horizontally disposed optical element having a top surface disposed adjacent to the bottom surface of the light guide. The emitted light from the at least one horizontally disposed optical element has a shifted spatial power distribution of light due to the at least one horizontally disposed optical element to approximate a vertical Lambertian spatial power distribution and a horozontal Lambertian spatial power distribution. The emitted light from the at least one horizontally disposed optical element comprises a total zonal lumens of at least about 90-percent of the total zonal lumens emitted without the at least one horizontally disposed optical element. The light emitted from the solid state lighting fixture is non-polarized and operable to generally accurately reproduce colors of objects and comprises about 3,500 lumens. The work surface is illuminated with the non-polarized light having the shifted spatial power distribution to generally accurately reproduce colors of objects on the work surface. The light guide, the reflector, and the at least one at least one horizontally disposed optical element comprises at least one of a width and length of about 2 feet by about 2 feet, and a width and length of about 2 feet by about 4 feet.

In a third aspect, the present invention provides a solid state lighting fixture for illuminating a work surface. The solid state lighting fixture includes a solid state light source, a generally horizontally disposed, planar elongated light guide for receiving light from the solid state light source and emitting the light from a generally horizontally disposed first surface of the light guide, a reflector disposed adjacent to a second horizontal surface of the light guide for redirecting some of the light from the surface back into the light guide, and at least one horizontally disposed optical element having a first surface disposed adjacent to the first surface of the light guide for receiving the light emitted from the light guide and emitting the light from a second horizontally disposed surface of the at least one horizontally disposed optical element. The at least one horizontally disposed optical element is operable to shift the spatial power distribution of emitted light due to the at least one horizontally disposed optical element to more closely approximate a vertical Lambertian spatial power distribution and a horozontal Lambertian spatial power distribution. The emitted light from the at least one horizontally disposed optical element comprises a total zonal lumens over the spatial power distribution of at least about 90-percent of the total zonal lumens emitted without the at least one horizontally disposed optical element. The solid state lighting fixture is configured to produce non-polarized light to generally accurately reproduce colors of objects, and the light emitted from the solid state light fixture comprises about 600 lumens to about 6,000 lumens.

In a fourth aspect, the present invention provides a solid state lighting fixture for illuminating a work surface. The solid state lighting fixture includes a solid state light source, a generally horizontally disposed, planar elongated light guide for receiving light from the solid state light source and emitting the light from a generally horizontally disposed first surface of the light guide, a reflector disposed adjacent to a second horizontal surface of the light guide for redirecting some of the light from the surface back into the light guide, and at least one horizontally disposed optical element having a first surface disposed adjacent to the first surface of the light guide for receiving the light emitted from the light guide and emitting the light from a second horizontally disposed surface of the at least one horizontally disposed optical element. The at least one horizontally disposed optical element operable to shift the spatial power distribution of emitted light due to the at least one horizontally disposed optical element to approximate a vertical Lambertian spatial power distribution and a horozontal Lambertian spatial power distribution. The emitted light from the at least one horizontally disposed optical element comprising a total zonal lumens of at least about 90-percent of the total zonal lumens emitted without said at least one horizontally disposed optical element. The solid state lighting fixture being configured to produce non-polarized light to generally accurately reproduce colors of objects, the light guide and at least optical element comprises a width and length of at least one of about 2 feet, and about 2 feet by about 4 feet, and light emitted from the solid state lighting fixture comprising about 3,500 lumens.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a perspective view of a prior art florescent lighting fixture;

FIG. 2 is a polar plot illustrating a spatial power distribution curve of light emitted from the lighting fixture of FIG. 1;

FIG. 3 is a graphical representation of four spatial power distribution curves for a light source;

FIG. 4 is a graph of zonal constants verses angle relative to a solid state lighting fixture;

FIG. 5 partial cross-sectional view of one embodiment of a solid state lighting fixture in accordance with the present invention;

FIG. 6 partial cross-sectional view of another embodiment of a solid state lighting fixture in accordance with the present invention which includes a single diffuser;

FIG. 7 is a table of the measurements of the solid state lighting fixtures of FIG. 5, and FIG. 6 having different diffusers;

FIG. 8 is a polar plot for the test results for solid state lighting fixture having a SATIN ICE diffuser, e.g., as shown in FIG. 6;

FIG. 9 is a partial cross-sectional view of another embodiment of a solid state lighting fixture in accordance with the present invention which includes a clear prism sheet;

FIG. 10 is a partial cross-sectional view of another embodiment of a solid state lighting fixture in accordance with the present invention which includes the combination of a diffuser and clear prism sheet;

FIGS. 11 and 12 is a table of the measurements using the solid state lighting fixtures of FIGS. 9 and 10;

FIG. 13 is a partial cross-sectional view of another embodiment of a solid state lighting fixture in accordance with the present invention which includes a frosted prism sheet;

FIG. 14 is a partial cross-sectional view of another embodiment of a solid state lighting fixture in accordance with the present invention which includes the combination of a diffuser and frosted prism sheet;

FIGS. 15 and 16 is a table of the measurements using the solid state lighting fixtures of FIGS. 13 and 14; and

FIGS. 17 and 18 is a table of the results of another embodiment of a solid state lighting fixture in accordance with the present invention having a combination of clear and frosted prisms.

### DETAILED DESCRIPTION OF THE INVENTION

In one aspect, the present invention is directed to optimizing the spatial power distribution for solid state lighting fixtures or luminaires which emit non-polarized light for generally reproducing colors of objects on a work surface. As described in greater detail below, one approach is by changing the optical elements that are being used to shape and soften the beam emitted by the solid state lighting such as a plurality of LEDs.

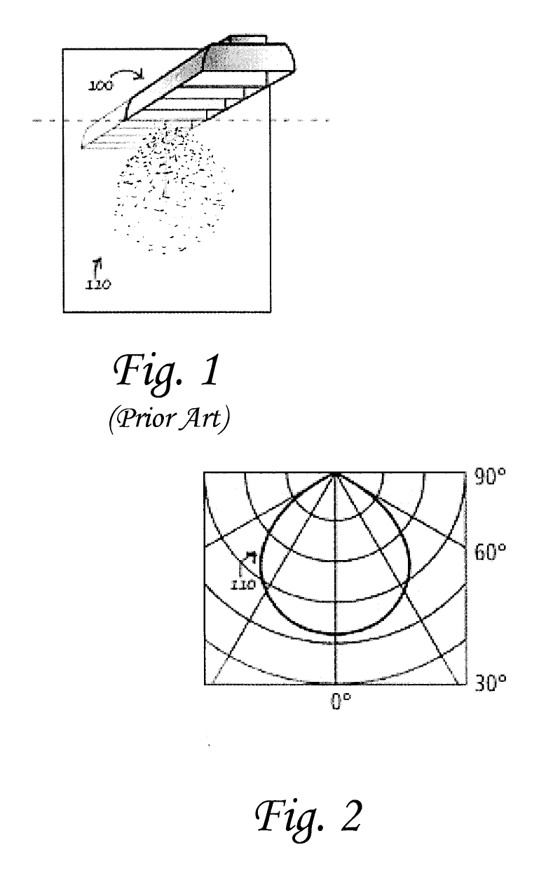

Initially, FIG. 1 illustrates a prior art lighting fixture 100 such as a florescent lighting fixture and an emitted light such as a beam 110. Luminous flux is the time rate of flow of light. Luminous flux can be compared to electric current, in amperes, the time rate of flow of an electric charge. The unit of measure of luminous flux is the lumen. A lamp or light source receives watts and emits lumens. The measure of its success in doing this is called efficacy and is measured in lumens per watt.

While measuring the wattage of a light source is relatively straight forward, the method for determining the total lumens of a lighting device is a function of the distribution of the light source. Lighting intensity is often graphically represented in polar plots. The polar plots allow for the visualization of the spatial power distribution of the light, e.g., the shape of the beam.

The shape of beam 110 may be represented in a corresponding polar plot as shown in FIG. 2. The zero degree angle, the nadir, is in a plane perpendicular to the front of the fixture, e.g., vertical orientation. Ninety degrees lies in a plane parallel to the front of the fixture, e.g., horizontal orientation. Each angle in between can be broken up into different ranges or zones. For example, FIG. 2 illustrates three zones, a first zone between 0-30 degrees, a second zone between 30-60 degrees, and a third zone between 60-90 degrees.

The total output can be derived by taking the average plot reading in each of these zones and multiplying by a weighting factor that is unique to each zone. The weighting factor is called the zonal constant. Weighting factors increase farther away from the nadir as is seen in the table. The lumens for a particular zone are defined as the average light intensity, measured in candelas, multiplied by the zonal constant for that zone. Total zonal lumens are defined as the sum of all the zonal lumen products in the lighting intensity distribution curve.

| Zone | Zonal Constant |
|---|---|
| 0-30 | 0.8 |
| 30-60 | 2.3 |
| 60-90 | 3.1 |

There are four ideal spatial power intensity distribution curves for a light source. One intensity distribution is a cosine or vertical and horizontal Lambertian spatial power distribution. That means that the distribution emitted by a light source is very nearly even in every direction and its shape resembles that of a circle. Not all cosine distributions are equal. A cosine distribution that has more surface area under the curve but which is stretched out toward the 0 degrees, e.g., directly below the lighting fixture will have much less total lumens than a slightly rounder cosine distribution with less area under its polar plot because of the benefit of zonal lumens.

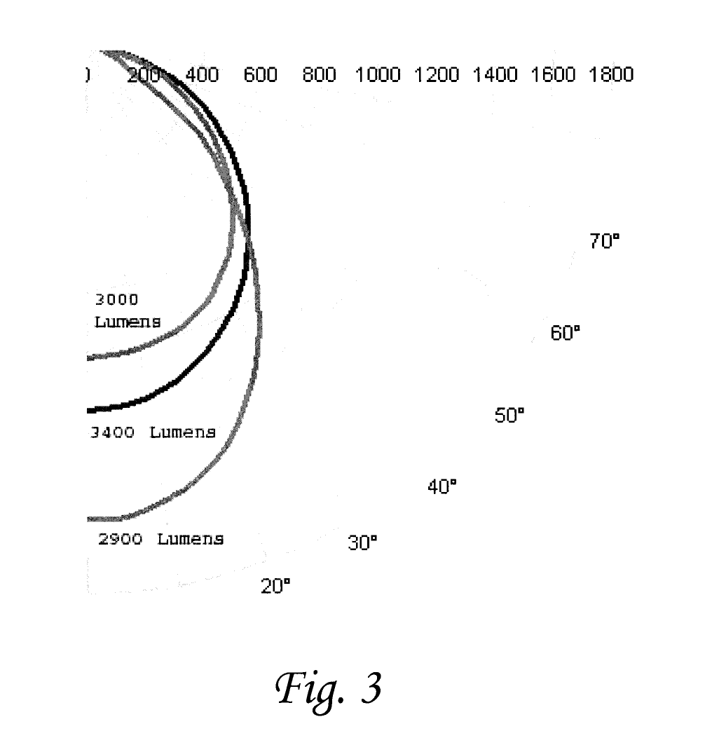

FIG. 3 illustrates three zonal lumen plots for similar light sources with different optical elements shaping the beam. The plot corresponding to 2,900 lumens has much more area under its curve than the 3,000 lumen curve, yet there is still considered to be less output from the fixture because it places more energy in the 0-30 zone than the 3,000 lumen curve. The curve corresponding to the 3,400 lumen output has a similar shape as the 3,000 lumen curve. It has more energy in the 30-60 zone, however, which corresponds to a greater output reading.

Consideration is given to the weighting of zonal constants. In typical applications at normal mounting heights, it is important to direct light effectively down to the work surface. Coefficient of Utilization is a metric that describes how effectively light gets down to the work surface. Surprisingly, however, the coefficient is a function of how effectively light works with the walls and ceilings of the environment. In other words, it emphasizes the importance of directing light out to the sides as much as it does directing light downward. Zonal constants were developed to emphasize this tendency. There is also a zonal lumen density requirement that is a function of code for certain energy efficiency programs, such as ENERGY STAR for Solid State Lighting Luminaires. The zonal lumen density requirement states that the luminaires shall deliver a minimum of 75-percent of total zonal lumens within the 0-60 degree zone.

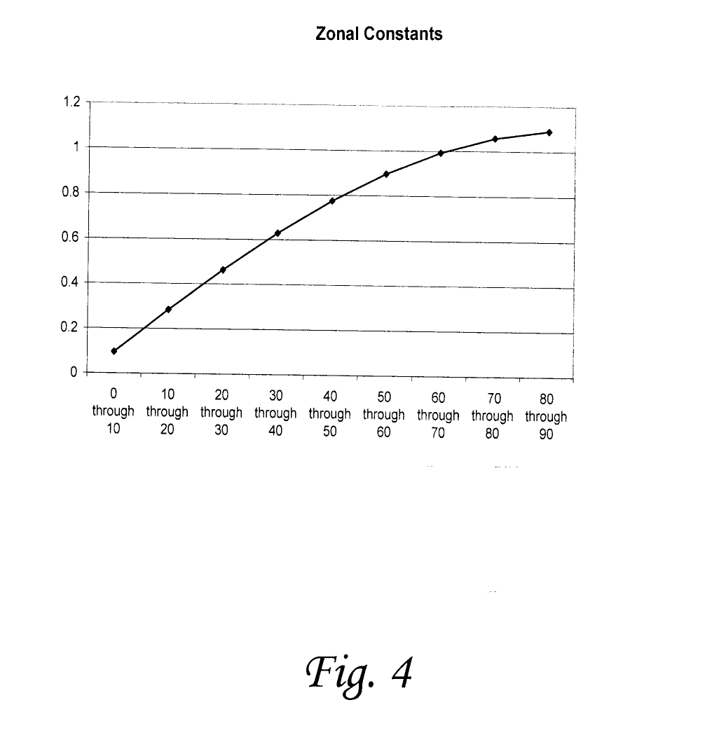

Another consideration is the fall off of zonal constants as 90 degrees is approached. FIG. 4 illustrates a linear increase of zonal constants until approximately 60 degrees where the increase begins to abate. This can be seen in the plateau effect on the graph. This is balanced in a cosine distribution with the fact that candela values will naturally depreciate significantly in the 60-90 degree zone.

In one aspect, the present invention is directed to optimizing the ideal cosine distribution. One approach is by changing the optical elements that are being used to shape and soften the beam. The optical elements may include diffusers, angular prismatic elements, etc., or combination thereof.

Diffusers, for example, “fatten” the distribution by spreading the beam out. Some diffusers work by using a long chain polymer that disrupts the light path slightly. Other diffusers use surface abrasion, which breaks up the path by creating a series of different surface angles for the beam of light to leave the medium. This results in an inordinate amount of light bouncing back into the fixture resulting in losses. Therefore, long chain polymer diffusers are preferred. The ratio of polymers in the material, usually either acrylic or polycarbonate, defines the level of diffusion. The higher the ratio, the more diffusion there is. The more diffusion there is, the more the light will spread into the obtuse angles.

Another method of manipulating light is through angular prism optical elements which direct light in certain planes through polarization.

It is possible to manipulate the spatial power distribution through diffusers, prisms and light guides in most luminaire types in order to maximize the total output.

In another aspect, the present invention comprises lighting fixtures that emit light with a cosine spatial power density. Through a process of careful manipulation and combination of optical elements a lighting fixture is provided that maximizes the possible total zonal lumens for a fixture with a cosine intensity distribution. The data included illustrates the testing results for many variations of optical elements to achieve the maximum output for a cosine distribution. It is verified with a mathematical model and the results match the mathematical model for maximization of total lumens.

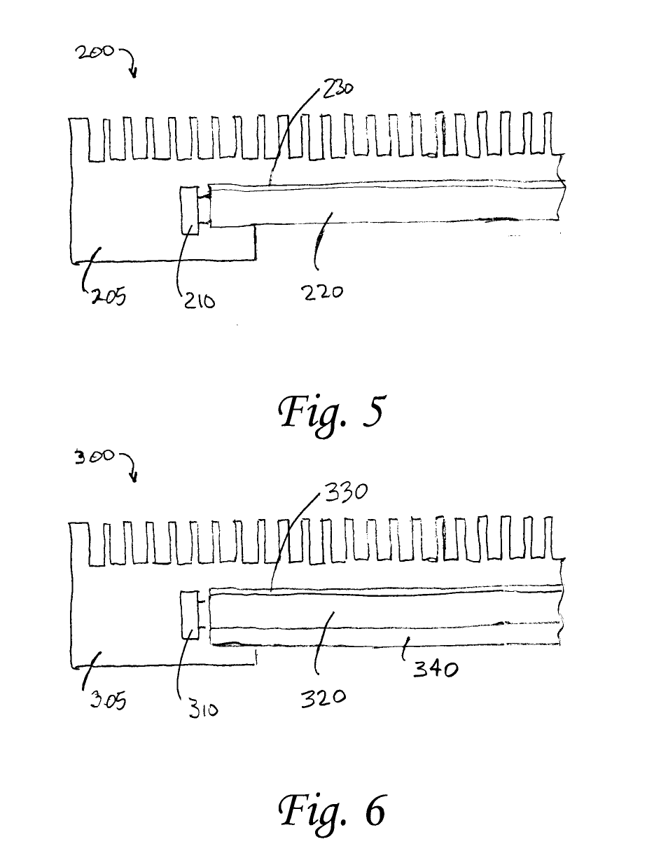

FIG. 5 illustrates a partial cross-sectional view of an exemplary embodiment of a lighting fixture 200 in accordance with the present invention. In this exemplary embodiment, a series of optical elements are bound by a frame 205. Light is emitted from an solid state device 210 such as at least one light emitting diode (LED) and preferably a plurality of LEDs into a light guide 220. Light may be prohibited from exiting the top of the fixture by the reflector 230 and redirected back into the light guide 220. The reflector may be a specular reflector (e.g., a mirror), a diffuse reflector (e.g., a white opaque material), or material operable to provide a combination of specular or diffuse reflection. For example, the reflector may be a MYLAR or polyester film containing titanium oxide. In some embodiments, the reflector may include holes to allow some of the light in the light guide to exit towards the top of the light fixture.

FIG. 6 illustrates a cross-sectional view of an exemplary embodiment of a lighting fixture 300 in accordance with the present invention which includes an optical element such as a single diffuser. In this example, a series of optical elements are bound by a frame 305. Light is emitted from a solid state device 310 such as at least one light emitting diode and preferably a plurality of LEDs into a light guide 320. Light may be prohibited from exiting the top of the fixture by the reflector 330 and redirected back into the light guide 320. The reflector may be a specular reflector (e.g., a mirror), a diffuse reflector (e.g., a white opaque material), or material operable to provide a combination of specular or diffuse reflection. For example, the reflector may be a MYLAR or polyester film containing titanium oxide. The reflector may include holes to allow some of the light in the light guide to exit towards the top of the light fixture. Light exiting the light guide then passes through a diffuser 340.

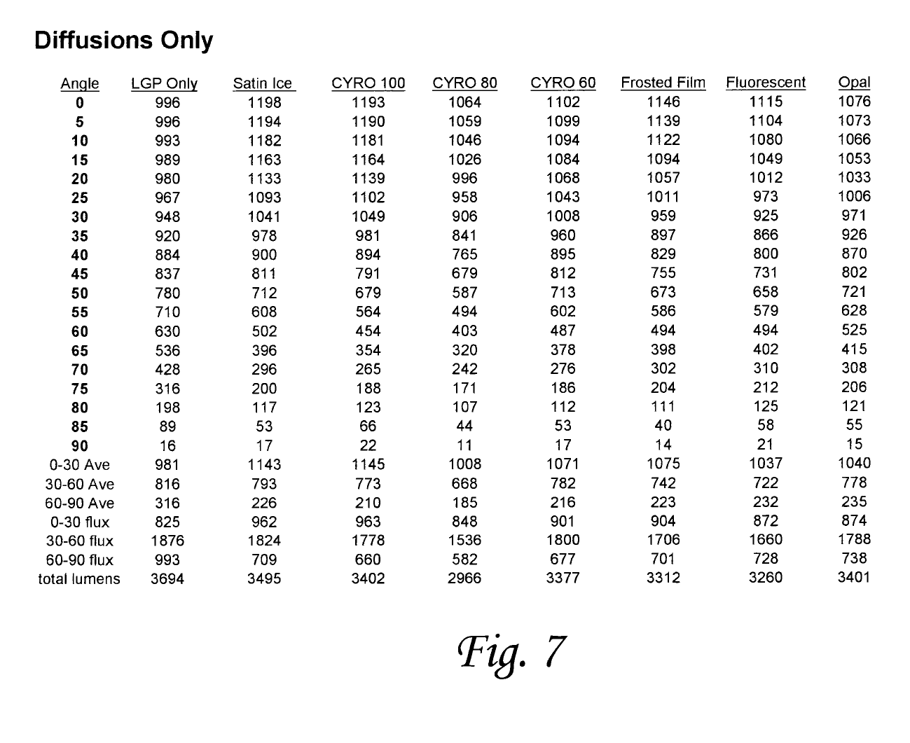

FIG. 7 is a table of the measurements of the lighting fixture of FIGS. 5 and 6 with measured candela readings given in five degree increments. Also compiled in FIG. 7 are the average candela readings within predetermined zones of 0-30, 30-60 and 60-90 degrees. The average candela reading in each zone is multiplied by the zonal constant for the three zones to arrive at the zonal lumens (e.g., 0-3-flux, 30-60 flux, and 60-90 flux). The total zonal lumens is the sum of the zonal lumens.

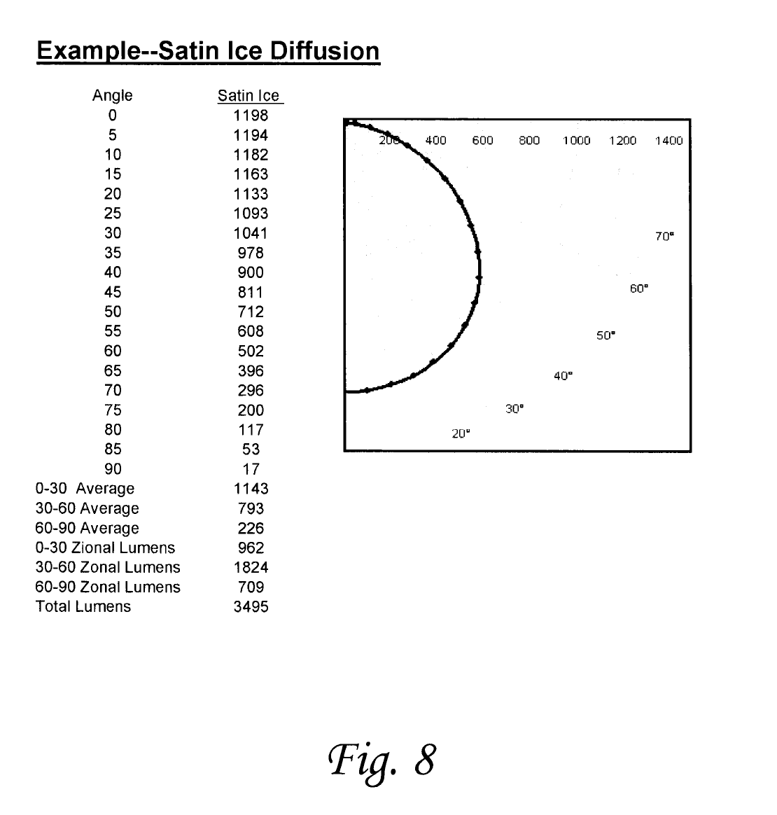

In the exemplary embodiment shown in FIG. 6 having and with the different diffusers tested, the SATIN ICE diffuser provides the greatest total zonal lumens. A polar plot for the corresponding candela distribution for the SATIN ICE diffuser is shown in FIG. 8. It is noticed that the SATIN ICE diffuser provides very near ideal output. The distribution is almost spherical, which is the definition of a perfect diffuser. The ideal curve however is a few degrees less than spherical or it has a taper in the 70-90 degree zones to account for the plateau in zonal constant increases for that range. The SATIN ICE diffuser which provided the results listed had a thickness of about 3 mm. The SATIN ICE diffuser resulted in a transmission of about 95-percent of the light compared to light transmitted out of the light guide alone (e.g., 3,495 total zonal lumens divided by 3,694 total zonal lumens without the diffuser).

SATIN ICE comprises a diffuser available from CYRO Industries, Germany. SATIN ICE is part of a general CYRO product line called Acyrylite, which are a range of methacrylates. SATIN ICE is an acrylic material (polymethyl methacrylate, PMMA) that contains special diffuser beads. Each of the spherical polymer particles therefore deflects impinging light rays in a special way, toward the service side. As a result, hardly any light is reflected or absorbed, i.e. SATIN ICE offers high light transmission paired with light diffusion. In SATIN ICE, according to its data sheet, spherical bead polymers are embedded in the material that has transmission coupled with diffusion properties. SATIN ICE gets its “milky white” appearance from diffusion and not pigmentation which causes light absorption in other white methacrlates. More importantly, while the transmission of SATIN ICE is enhanced in the 0-60 degree zone, it has less transmission in the 60-90 degree zone than the average milk PLEXIGLAS. This has the effect of tapering the spectral power distribution.

Another consideration for diffusion is transmission. If a heavy diffuser is placed in front of a lighting fixture, the polar plot will assume a very nearly spherical shape. What is important in this case is not so much how well the optical material creates a spherical distribution; it is how efficiently it creates that distribution. In other words, it is desirable to maximize the transmission while achieving the curve. This will result in overall candela readings that are proportional to the degree of transmission. The heavier the diffusion, the less transmission will be for that medium.

With reference again to FIG. 5, the lighting fixture 200 having a reflector and light guide (column 1 labeled LPG Only in FIG. 7) resulted in total lumens of 3,694. It will be appreciated by those skilled in the art that the diffuser, light guide itself, of other means may be employed to frustrate total internal reflection (TIR) and to distribute the light emitted from the solid state light sources uniformly across the light-guide surface. For example, rulings (such as scratches) on the surface of the light guide, dots of white paint painted on the surface of the light guide, etc. may be employed with a reflector to more closely approximate a Lambertian spatial power distribution. For example, the number of or density of dots or rulings on the light guide may be greater further away from the solid state light source than the number of or density of dots or rulings closer to the solid state light source.

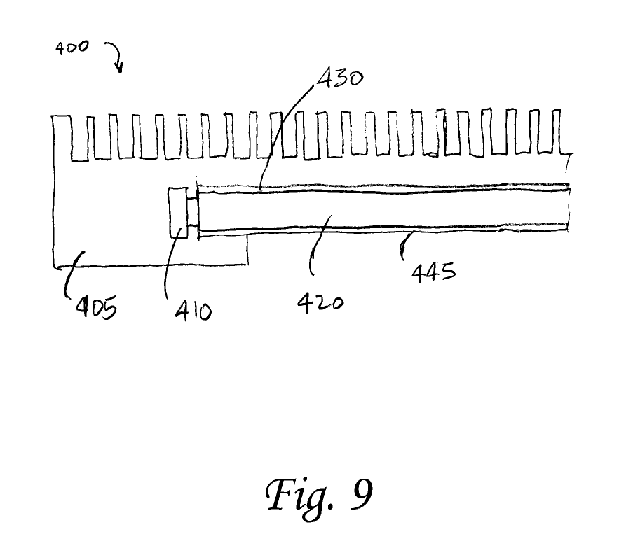

FIG. 9 illustrates a partial cross-sectional view of another exemplary embodiment of a lighting fixture 400 in accordance with the present invention which includes a clear prism sheet. In this example, a series of optical elements which are bound by a frame 405. Light is emitted from a solid state device 410 such as at least one light emitting diode and preferably a plurality of LEDs into a light guide 420. Light may be prohibited from exiting the top of the fixture by the reflector 430 and redirected back into the light guide 420. The reflector may be a specular reflector (e.g., a mirror), a diffuse reflector (e.g., a white opaque material), or material operable to provide a combination of specular or diffuse reflection. For example, the reflector may be a MYLAR or polyester film containing titanium oxide. The reflector may include holes to allow some of the light in the light guide to exit towards the top of the light fixture. Light exiting the light guide then passes through a diffuser 440.

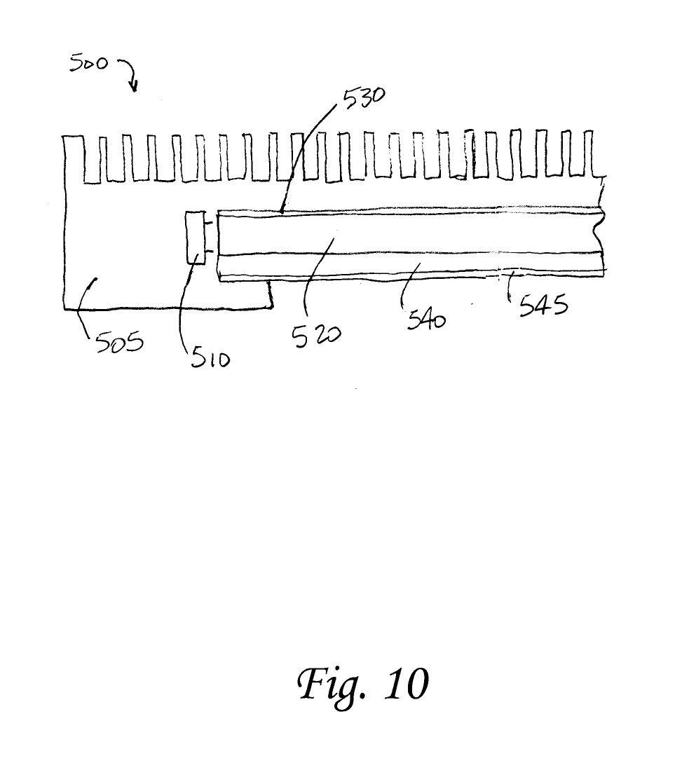

FIG. 10 illustrates a partial cross-sectional view of another exemplary embodiment of a lighting fixture 500 in accordance with the present invention which includes the combination of a diffuser and clear prism sheet. In this example, a series of optical elements is bound by a frame 505. Light is emitted from an solid state device 510 such as at least one light emitting diode and preferably a plurality of LEDs into a light guide 520. Light may be prohibited from exiting the top of the fixture by the reflector 530 and redirected back into the light guide 520. The reflector may be a specular reflector (e.g., a mirror), a diffuse reflector (e.g., a white opaque material), or material operable to provide a combination of specular or diffuse reflection. For example, the reflector may be a MYLAR or polyester film containing titanium oxide. The reflector may include holes to allow some of the light in the light guide to exit towards the top of the light fixture. Light exiting the light then passes through diffuser 540 and than a clear prism sheet 545. It will be appreciated that the positioning of the diffuser and the clear prism sheet may be reversed.

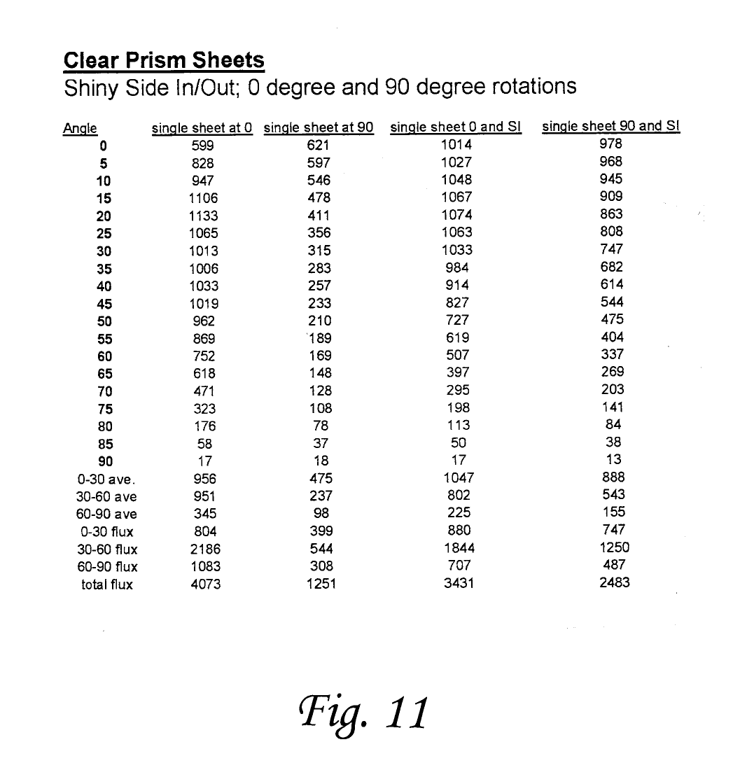

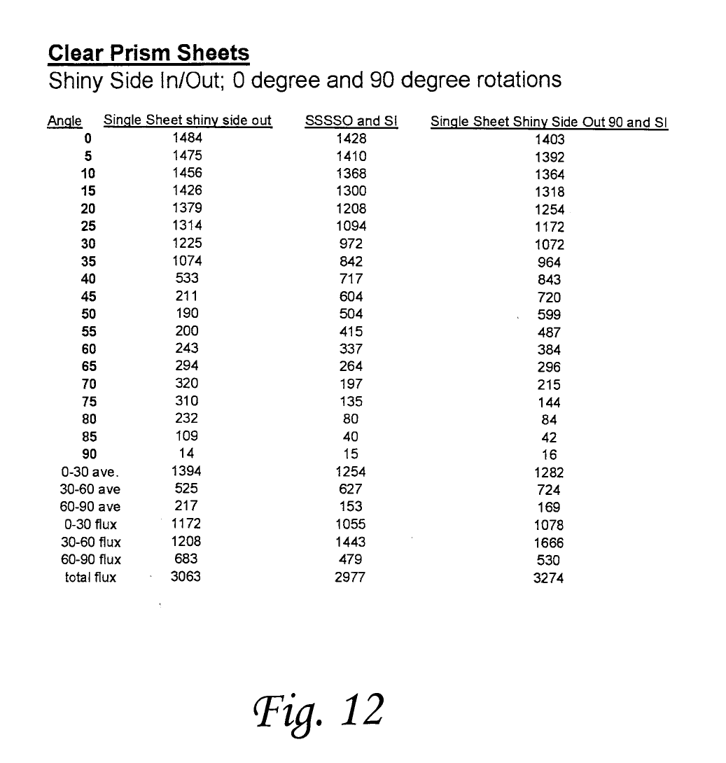

FIGS. 11 and 12 represent a table of the measurements of the lighting fixtures of FIGS. 9 and 10 with measured candela readings given in five degree increments and the arrangement of the clear prism sheets. Also compiled in FIGS. 11 and 12 are the average candela readings within predetermined zones of 0-30, 30-60, and 60-90 degrees. The average candela reading in each zone is multiplied by the zonal constant for the three zones to arrive at the zonal lumens (e.g., 0-3-flux, 30-60 flux, and 60-90 flux). The total zonal lumens is the sum of the zonal lumens.

One byproduct of clear prisms is that previously considered examples showed what is referred to as bilateral symmetry. The vertical angles 0-90 degrees that are listed are assumed to be the same as you rotate around the lighting fixture horizontally every 90 degrees. With the clear prisms, horizontal angles show very different results which can be seen for the vertical angles measurements for 0 degree labels and 90 degree labels. While this may be suitable for certain applications, this is not consistent with cosine distribution. Therefore, these test results were scrutinized for the prisms ability to create large gains in certain angles to be used in conjunction with diffusers and other prismatic optical elements.

For example, the single sheet at 0-degrees resulted in transmission of about 110-percent of the light compared to light transmitted out of the light guide alone (e.g., 4,073 total lumens divided by 3,694 lumens without the optical elements). It is noted that the percentage of total lumens between 0-degrees and 60-degrees is only about 73-percent. The single sheet at 0-degrees and SATIN ICE resulted in a resulted in a transmission of about 93-percent of the light compared to light transmitted out of the light guide alone (e.g., 3,431 total lumens divided by 3,694 lumens). The percentage of total lumens between 0-degrees and 60-degrees is about 79-percent.

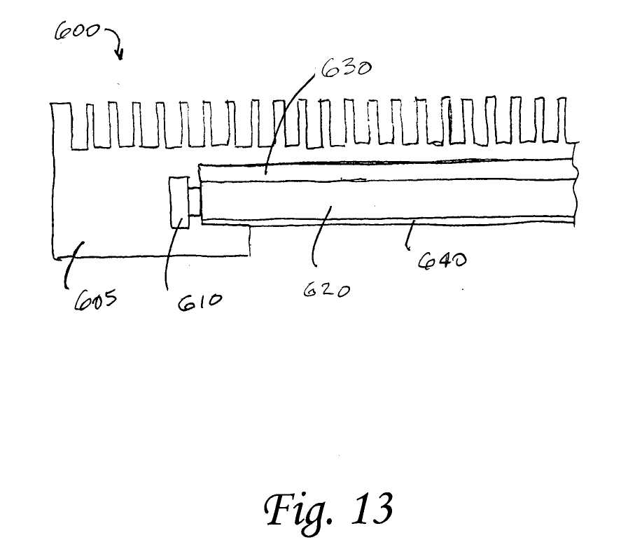

FIG. 13 illustrates a partial cross-sectional view of another exemplary embodiment of a lighting fixture 600 in accordance with the present invention which includes a frosted prism sheet. In this example, a series of optical elements is bound by a frame 605. Light is emitted from a solid state device 610 such as at least one light emitting diode and preferably a plurality of LEDs into a light guide 620. Light may be prohibited from exiting the top of the fixture by the reflector 630 and redirected back into the light guide 620. The reflector may be a specular reflector (e.g., a mirror), a diffuse reflector (e.g., a white opaque material), or material operable to provide a combination of specular or diffuse reflection. For example, the reflector may be a MYLAR or polyester film containing titanium oxide. The reflector may include holes to allow some of the light in the light guide to exit towards the top of the light fixture. Light exiting the light guide then passes through a frosted prism sheet 640.

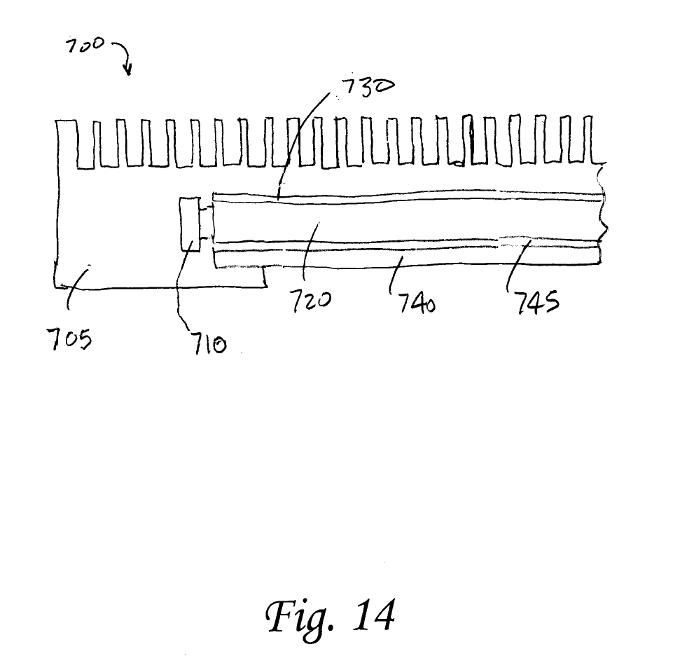

FIG. 14 illustrates a partial cross-sectional view of an exemplary embodiment of a lighting fixture 700 in accordance with the present invention which includes the combination of a diffuser and frosted prism sheet. In this example, a series of optical elements is bound by a frame 705. Light is emitted from a solid state device 710 such as at least one light emitting diode and preferably a plurality of LEDs into a light guide 720. Light may be prohibited from exiting the top of the fixture by the reflector 730 and redirected back into the light guide 720. The reflector may be a specular reflector (e.g., a mirror), a diffuse reflector (e.g., a white opaque material), or material operable to provide a combination of specular or diffuse reflection. For example, the reflector may be a MYLAR or polyester film containing titanium oxide. The reflector may include holes to allow some of the light in the light guide to exit towards the top of the light fixture. Light exiting the light then passes through diffuser 740 and than a clear prism sheet 745. It will be appreciated that the positioning of the diffuser and the prism sheet may be reversed. In other embodiments, the light exiting the light guide may be made to pass through a diffuser and a dear prism sheet.

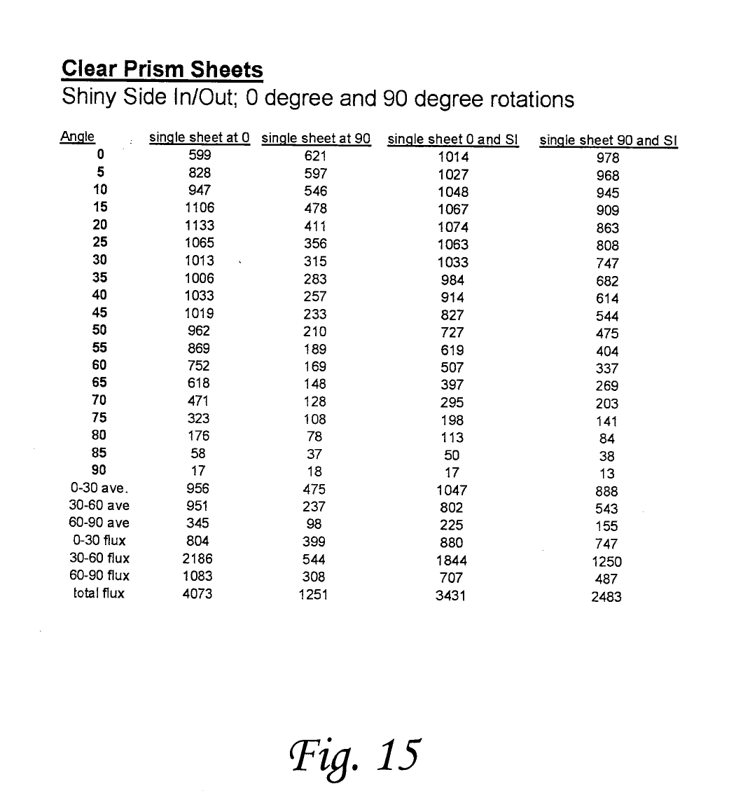

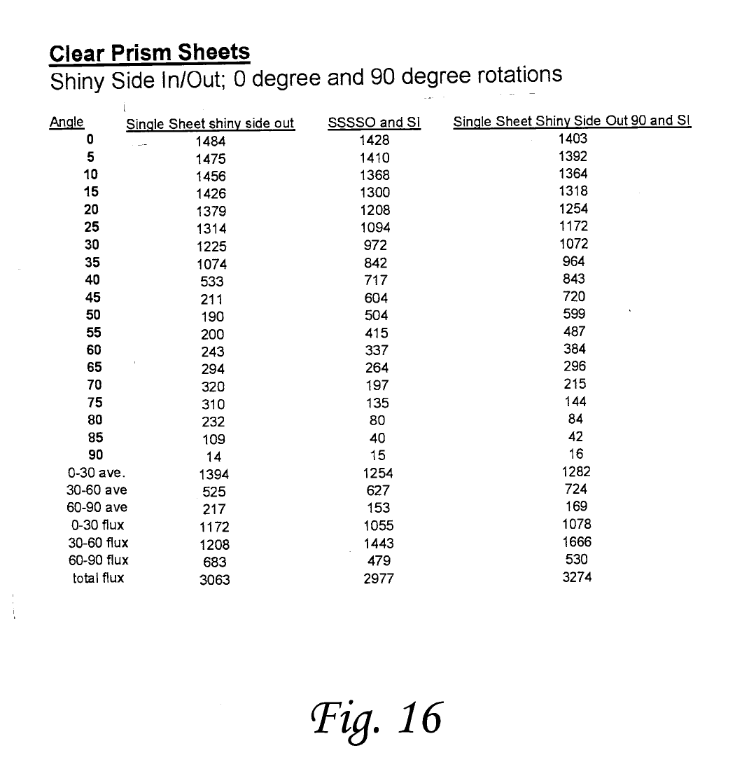

FIGS. 15 and 16 represents a table of the measurements of the lighting fixtures of FIGS. 13 and 14 with measured candela readings given in five degree increments and the arrangement of the frosted prism sheets. In addition, compiled in FIGS. 15 and 16 are the average candela readings within predetermined zones of 0-30, 30-60, and 60-90 degrees. The average candela reading in each zone is multiplied by the zonal constant for the three zones to arrive at the zonal lumens (e.g., 0-3-flux, 30-60 flux, and 60-90 flux). The total zonal lumens is the sum of the zonal lumens.

While the center beam candela readings were desirable, the fall off in the 45-90 degree zones was too steep, which compromised the total lumens. As a result, we tested the ability of the diffusers to spread out the beam enough to achieve higher lumens than the SATIN ICE example. None succeeded in matching due to compromised transmission.

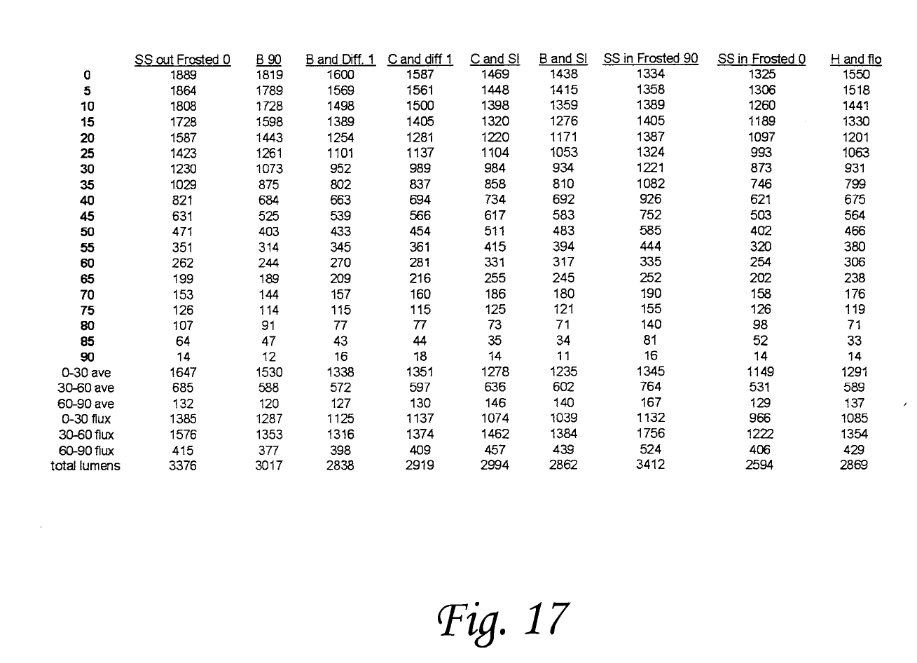

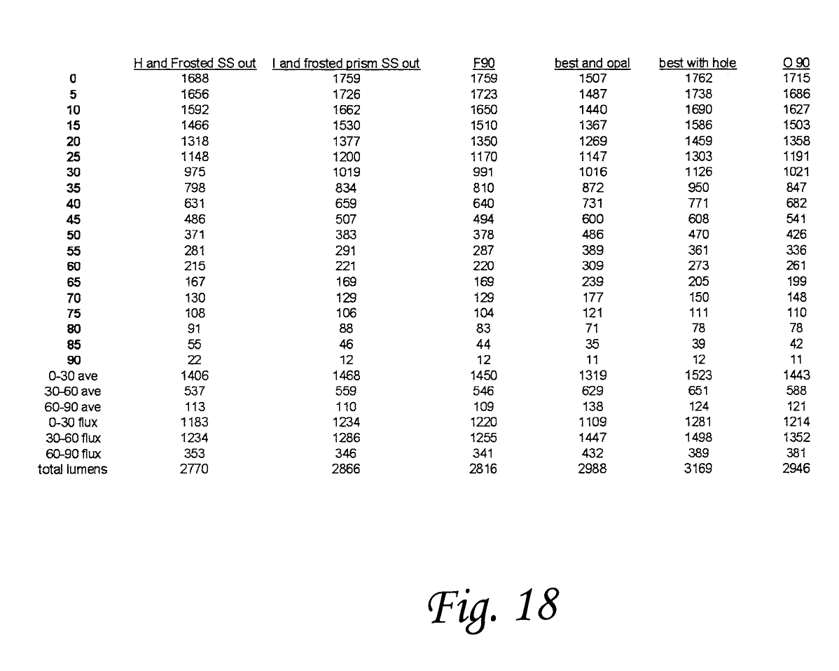

FIGS. 16 and 17 finally shows the combination of clear and frosted prisms, which yielded some interesting results but not as high as the SATIN ICE test case.

From the present description, it will be appreciated that for lighting fixtures, it is desirable that the above-described lighting fixtures have a high color rendering index (CRI) (sometimes called color rendition index), is a quantitative measure of the ability of a light source to reproduce the colors of various objects faithfully in comparison with an ideal or natural light source.

In the above noted embodiments, the diffuser may include nanoparticles having a size greater the wavelengths of visible light or having a size smaller than the wavelengths of visible light. Such nanoparticles may allow tailoring the diffuser to optimize the Lamtertian spatial power distribution of light emitted from the lighting fixture.

The light emitted from the various embodiments of the lighting fixtures, may be about 600 lumens to about 6,000 lumens, and preferably about 3,500 lumens. The various embodiments of the lighting fixtures may be about 2 feet to about 2 feet, 2 feet by about 4 feet, 1 foot by 2 feet, 1 foot by 4 feet, or other configurations.

Thus, while various embodiments of the present invention have been illustrated and described, it will be appreciated to those skilled in the art that many changes and modifications may be made thereunto without departing from the spirit and scope of the invention.

1. A method for illuminating a work surface using a solid state lighting fixture, the method comprising:
generating light from a solid state light source;
introducing the light from the solid state light source into a generally horizontally disposed planar light guide;
reflecting some of the light from a reflector disposed adjacent to a horizontally disposed top surface of the light guide back into the light guide;
introducing the light emitted from a horizontally disposed bottom surface of the light guide into at least one horizontally disposed optical element having a top surface disposed adjacent to the bottom surface of the light guide;
emitting light from the at least one horizontally disposed optical element having a shifted spatial power distribution of light due to the at least one horizontally disposed optical element to more closely approximate a vertical Lambertian spatial power distribution and a horozontal Lambertian spatial power distribution compared to the spatial power distributions of the light without the at least one horizontally disposed optical element, the emitted light from the at least one horizontally disposed optical element comprising a total zonal lumens of at least about 90-percent of the total zonal lumens emitted without the at least one horizontally disposed optical element, and the emitted light is non-polarized and operable to generally accurately reproduce colors of objects; and
illuminating the work surface with the non-polarized light having the shifted spatial power distribution to generally accurately reproduce colors of objects on the work surface.

2. The method of claim 1 wherein the emitted light from the at least one horizontally disposed optical element comprises a total zonal lumens at least about 95-percent of the total zonal lumens emitted without the at least one horizontally disposed optical element.

3. The method of claim 1 wherein the emitting light from the at least one horizontally disposed optical element has a shifted spatial power distribution approximating a vertical and horizontal Lambertian spatial power distribution.

4. The method of claim 1 wherein the emitted light from the at least one horizontally disposed optical element comprising a total zonal lumens of at least about 95-percent of the total zonal lumens emitted without the at least one horizontally disposed optical element, and the emitted light from the at least one horizontally disposed optical element having a shifted spatial power distribution approximating a vertical and horizontal Lambertian spatial power distribution.

5. The method of claim 1 wherein the introducing the emitted light from the light guide through at least one horizontally disposed optical element comprises introducing the emitted light from the light guide through an acrylic material comprising a diffusing material.

6. The method of claim 1 wherein the introducing the emitted light from the light guide through at least one horizontally disposed optical element comprises introducing the emitted light from the light guide through a SATIN ICE acrylic diffuser having a thickness of about 3 mm.

7. The method of claim 1 wherein the at least one optical element comprises a plurality of optical elements.

8. The method of claim 1 wherein the introducing the emitted light from the light guide through at least one horizontally disposed optical element comprises introducing the emitted light from the light guide through a diffuser and at least one prism sheet.

9. The method of claim 1 wherein the light guide, the reflector, and the at least one horizontally disposed optical element comprises a width and length of about 2 feet by about 2 feet.

10. The method of claim 1 wherein the light guide, the reflector, and the at least one horizontally disposed optical element comprises a width and length of about 2 feet by about 4 feet.

11. The method of claim 1 wherein the emitting light from the solid state lighting fixture comprises about 600 lumens to about 6,000 lumens.

12. The method of claim 1 wherein the emitting light from the solid state lighting fixture comprises about 3,500 lumens.

13. The method of claim 1 wherein the solid state light source comprises a plurality of light emitting diodes.

14. A method for illuminating a work surface using a solid state lighting fixture, the method comprising:
generating light from a solid state light source;
introducing the light from the solid state light source into a generally horizontally disposed planar light guide;
reflecting some of the light from a reflector disposed adjacent to a horizontally disposed top surface of the light guide back into the light guide;
introducing the light emitted from the horizontally disposed bottom surface of the light guide into at least one horizontally disposed optical element having a top surface disposed adjacent to the bottom surface of the light guide;
emitting light from the at least one horizontally disposed optical element having a shifted spatial power distribution of light due to the at least one horizontally disposed optical element to approximate a vertical Lambertian spatial power distribution and a horozontal Lambertian spatial power distribution, the emitted light from the at least one horizontally disposed optical element comprising a total zonal lumens over the spatial power distribution of at least about 90-percent of the total zonal lumens emitted without the at least one horizontally disposed optical element, the emitted light from the solid state lighting fixture is non-polarized and operable to generally accurately reproduce colors of objects and comprises about 3,500 lumens;
illuminating the work surface with the non-polarized light having the shifted spatial power distribution to generally accurately reproduce colors of objects on the work surface; and
wherein the light guide, the reflector, and the at least one at least one horizontally disposed optical element comprises at least one of a width and length of about 2 feet by about 2 feet, and a width and length of about 2 feet by about 4 feet.

15. The method of claim 14 wherein the emitted light from the at least one horizontally disposed optical element comprises a total zonal lumens at least about 95-percent of the total zonal lumens emitted without the at least one horizontally disposed optical element.

16. The method of claim 14 wherein the introducing the emitted light from the light guide through at least one horizontally disposed optical element comprises introducing the emitted light from the light guide through an acrylic material comprising a diffusing material.

17. The method of claim 14 wherein the introducing the emitted light from the light guide through at least one horizontally disposed optical element comprises introducing the emitted light from the light guide through a SATIN ICE acrylic diffuser having a thickness of about 3 mm.

18. The method of claim 14 wherein the introducing the emitted light from the light guide through at least one horizontally disposed optical element comprises introducing the emitted light from the light guide through a diffuser and at least one prism sheet.

19. The method of claim 1 wherein the solid state light source comprises a plurality of light emitting diodes.

20. A solid state lighting fixture for illuminating a work surface, said solid state lighting fixture comprising:
a solid state light source;
a generally horizontally disposed, planar elongated light guide for receiving light from said solid state light source and emitting the light from a generally horizontally disposed first surface of said light guide;
a reflector disposed adjacent to a second horizontal surface of the light guide for redirecting some of light from the surface back into the light guide;
at least one horizontally disposed optical element having a first surface disposed adjacent to said first surface of said light guide for receiving the light emitted from said light guide and emitting light from a second horizontally disposed surface of said at least one horizontally disposed optical element, said at least one horizontally disposed optical element operable to shift the spatial power distribution of emitted light due to the at least one horizontally disposed optical element to more closely approximate a vertical Lambertian spatial power distribution and a horozontal Lambertian spatial power distribution, the emitted light from said at least one horizontally disposed optical element comprising a total zonal lumens of at least about 90-percent of the total zonal lumens emitted without said at least one horizontally disposed optical element;
said solid state lighting fixture being configured to produce non-polarized light to generally accurately reproduce colors of objects; and
light emitted from said solid state lighting fixture comprising about 600 lumens to about 6,000 lumens.

21. The solid state lighting fixture of claim 20 wherein said at least one optimal element comprises an acrylic material comprising a diffusing material.

22. The solid state lighting fixture of claim 20 wherein said at least one optical element comprises a SATIN ICE acrylic diffuser having a thickness of about 3 mm.

23. The solid state lighting fixture of claim 20 wherein said at least one optical element comprises a plurality of optical elements.

24. The solid state lighting fixture of claim 20 wherein said at least one optical element comprises a diffuser and at least one prism sheet.

25. The solid state lighting fixture of claim 24 wherein said at least one prism sheet comprises at least one clear prism sheet disposed at about 0-degrees.

26. The solid state lighting fixture of claim 24 wherein said at least one prism sheet comprises at least one frosted prism sheet.

27. The solid state lighting fixture of claim 24 wherein said at least one optical element comprises a SATIN ICE acrylic diffuser and at least one prism sheet.

28. The solid state lighting fixture of claim 20 wherein said at least one optical panel comprises at least one clear prism sheet and at least one frosted prism sheet.

29. The solid state lighting fixture of claim 20 wherein said light guide and at least optical element comprise a width and length of about 2 feet by about 2 feet.

30. The solid state lighting fixture of claim 20 wherein said light guide and at least optical element comprise a width and length of about 2 feet by about 4 feet.

31. The solid state lighting fixture of claim 20 wherein the light emitted from said light fixture comprises about 3,500 lumens.

32. The solid state lighting fixture of claim 20 wherein said solid state light source comprises a plurality of light emitting diodes.

33. A solid state lighting fixture for illuminating a work surface, said solid state lighting fixture comprising:
a solid state light source;
a generally horizontally disposed, planar elongated light guide for receiving light from said solid state light source and emitting light from a generally horizontally disposed first surface of said light guide;
a reflector disposed adjacent to a second horizontal surface of the light guide for redirecting some of the light from the surface back into the light guide;
at least one horizontally disposed optical element having a first surface disposed adjacent to said first surface of said light guide for receiving light emitted from said light guide and emitting light from a second horizontally disposed surface of said at least one horizontally disposed optical element, said at least one horizontally disposed optical element operable to shift the spatial power distribution of emitted light due to the at least one horizontally disposed optical element to approximate a vertical Lambertian spatial power distribution and a horozontal Lambertian spatial power distribution, the emitted light from said at least one horizontally disposed optical element comprising a total zonal lumens over the spatial power distribution of at least about 90-percent of the total zonal lumens emitted without said at least one horizontally disposed optical element;
said solid state lighting fixture being configured to produce non-polarized light to generally accurately reproduce colors of objects;
said light guide and at least optical element comprising a width and length of at least one of about 2 feet by about 2 feet, and about 2 feet by about 4 feet; and
the light emitted from said solid state lighting fixture comprising about 3,500 lumens.

34. The solid state lighting fixture of claim 33 wherein said at least one optimal element comprises a SATIN ICE acrylic diffuser having a thickness of about 3 mm.

35. The solid state lighting fixture of claim 33 wherein said at least one optimal element comprises a plurality of optical elements.

36. The solid state lighting fixture of claim 33 wherein said at least one optical element comprising a diffuser and at least one prism sheet.

37. The solid state lighting fixture of claim 33 wherein said at least one optical element comprising a plurality of prism sheets.

38. The solid state lighting fixture of claim 33 wherein said at least one optical element comprising at least one clear prism sheet and at least one frosted prism sheet.

39. The solid state lighting fixture of claim 33 wherein said solid state light source comprises a plurality of light emitting diodes.

40. A method for illuminating a work surface comprising:
providing the solid state lighting fixture of claim 20; and
illuminating the work surface with the non-polarized light having and having the vertical and horizontal Lambertian spatial power distribution to generally accurately reproduce colors of objects on the work surface.

41. A method for illuminating a work surface comprising:
providing the solid state lighting fixture of claim 33; and
illuminating the work surface with the non-polarized light having the vertical and horizontal Lambertian spatial power distribution to generally accurately reproduce colors of objects on the work surface.
